(19) United States
(12) Patent Application Publication
(10) Pub. No.: US 2008/0086485 A1
(43) Pub. Date: Apr. 10, 2008

(54) Process and system for tracking, combining and reporting on data from multiple organizations

(76) Inventor: Thomas M. Paper, San Francisco, CA (US)

Correspondence Address: DERGOSITS & NOAH LLP, FOUR EMBARCADERO CENTER, SUITE 1450, SAN FRANCISCO, CA, 94111, US

(21) Appl. No.: 11/973,017

(22) Filed: Oct. 4, 2007

Related U.S. Application Data
(60) Provisional application No. 60/828,601, filed on Oct. 6, 2006.

(51) Int. Cl. G06F 17/30

(52) U.S. Cl. 707/10; 707/E17.005

(57) ABSTRACT

What is disclosed is a process and system for storing, combining, reporting and presenting data from multiple platforms. An embodiment of the present invention permits single or multiple platforms to present data for storage in a central database. Data may be added manually, imported in from another file or website, or may be created by applying a mathematical formula to a pre-existing set of data. This data, which forms a data set, may be further organized into data graphs, which may further be presented in a variety of different graphical representations. The different data sets and other visual representations may further organized by relevant topic into issue groups. According to one embodiment, the present invention will be displayed through a single interface accessible by any number of users through a network.

### RELATED APPLICATION DATA

This nonprovisional utility patent application claims priority under 35 U.S.C. § 119(e)(1) to provisional patent application No. 60/828,601, filed on Oct. 6, 2006.

### TECHNICAL FIELD

The present invention relates generally to using a system and method for the collection and display of data from multiple sources on a computer screen. Specifically, what is disclosed is a method and system for compiling data from a plurality of data sources and then displaying, analyzing, combining, allowing commentary upon and reporting of the data.

### BACKGROUND OF THE INVENTION

The public is constantly being exposed to data from a variety of sources. The media, government institutions, private and private organizations exist to gather, compile and produce data for audiences across the globe. It is difficult for a consumer of information to digest divergent sets of data if they are not readily viewable in one place. It is also difficult to determine the objectivity and veracity of the data. The source of the data may be called into question, and there are always issues of data manipulation and bias depending on the source.

Additionally, while there may be a great deal of data available to the public, the correlations and relationships between the data are not often published or understood. Those trying to elucidate such relationships between seemingly divergent data sets have no way of creating reports to easily discover these relationships. A system and process that would permit an interested party to take available data sets and visualizations of that data, and create new customizable data sets and visualizations of that data, would be very useful.

What is therefore needed is a process that can allow for either the entry or importing of data from different platforms or sources, or that will take data from existing sources and that will enable one collaborative system to store, calculate, graph and report on the different data into one collaborative series of graphs, tables, reports or the like.

What is further needed is a process for commenting, rating and/or evaluating the data for veracity or credibility. Any suggestions of bias or data contamination can be exposed or explained. The source of the data should be able to be made public to an audience. What is needed is a secure way to store the data, yet allow access by interested and/or permitted parties.

### SUMMARY OF THE INVENTION

The present invention is a software-enabled process and system for tracking, gathering, processing, compiling, combining, commenting on, reporting, storing and displaying data from multiple platforms and sources. It permits importing of data from another web address or source, and it also permits manual entry of data or use of existing data. The present invention effectively works as a diverse, multi-platform data repository, enabling subscribers and users to select desired data and data sources for commentary, compilation and display. The present invention also permits authorized users and subscribers to offer feedback on the data for quality, utility and veracity.

Data is uploaded or manually entered into a website that, in one embodiment, stores the data in a database. The individual data values may be combined into a graphical representation of the data called a “data graph.” The data graph can include data from related or divergent topics for correlation analysis. Data graphs from similar topics can be correlated to “issue groups” to facilitate presentation and retrieval by users of information on that topic. Upon formation of a data graph, a graphical representation of the data can be displayed, allowing the viewer to see if any visual relationships exist between the various elements of data. The data can also be manipulated and calculated upon using various statistical analysis techniques.

Data graphs and other uploaded images or documents, as well as tables of data may be combined to form “graph groups.” A graph group may display multiple graphical representations of data graphs, as well as other images or tables, for viewing in a single page accessed on a network or displayed as a single page in a report. In one embodiment, users can generate “reports” by combining multiple graph groups into a series of pages, either on a network or in a printed report. Additionally, in one embodiment, authorized analysts may offer feedback or commentary on the data.

In one embodiment, users may create or join “platforms” to hold and present their data, data graphs, graph groups and reports, as well as their commentary and the commentary of users. In one embodiment, a platform may have at least one “administrator” or “admin” who creates or provides the data, data graphs, graph groups and reports for that platform, as well as sets the permissions and responsibilities granted to “users” of that platform. In one embodiment, platforms may be labeled as public such that all information on or about the platform is made available to anyone on the network. In one embodiment, platforms may be labeled private such that information on the platform is available only to registered users of that platform. In one embodiment, permissions can be modified by the administrator such that specific users have specific permissions that allow access to limited portions of the platform.

An embodiment of the present invention creates an efficient and convenient way for collecting, tracking, combining, storing, reporting and evaluating data from a variety of sources. Data from these disparate sources, which may initially seem to lack any cohesive relationship, may be compiled to display what relationship may exist. This may in turn promote the dissemination and publication of objective and accurate information in a customizable way, while simultaneously revealing relationships and correlations between the different sets of information. This may also provide users with a single, easy-to-use platform for the sharing, comparison and publication of their data.

### BRIEF DESCRIPTION OF THE FIGURES

The present invention is illustrated by way of example and not limitation in the figures of the accompanying drawings, in which like references indicate similar elements, and in which:

FIG. 1 illustrates a client-server network that hosts the present invention, according to one embodiment of the present invention.

FIG. 2 is an exemplary block diagram of different elements of an embodiment of the present invention.

### DETAILED DESCRIPTION OF THE INVENTION

What is disclosed is a process and system for hosting, interrelating and displaying data from multiple platforms to create a single comprehensive database, according to one embodiment of the present invention. The present invention may provide for collaboration across a network, using a standardized system for tracking and reporting data. Each component within the system may be connected over a network or may be directly connected. One skilled in the art will recognize that the terms “network,” “computer network,” and “online” may be used interchangeably and do not imply a particular network embodiment or topography. In general, any type of network (e.g., LAN, WAN, or Internet) may be used to implement the online or computer networked embodiment of the present invention. The network may be maintained by a server (other than the backup server), or the network may be serverless. Similarly, any type of protocol (e.g., HTTP, FTP, ICMP, UDP, WAP, SIP, H.323, NDMP, TCP/IP) may be used to communicate across the network.

As described herein, the present invention utilizes some key terms to describe how it organizes and filters data. One skilled in the art would understand that the exact names of these key terms may change or expand over time, and that the definitions associated with these key terms are merely exemplary and not meant to limit the terms in any way. For example, an embodiment of the present invention may accept data from multiple sources, including manual data entry or automated upload to the system. An embodiment of the present invention may permit calculations or algorithms to be performed on the data. The calculation or algorithm may be user-specified or chosen from a bank of available methods. The results of such a calculation or algorithm may be used to create a new set of data for storage, manipulation and presentation. An embodiment of the present invention may enable a user to view data either numerically, graphically, as a slide show, in chart form or in any other representation helpful for viewing such data. An embodiment may cause display of the data on a computer screen, or may cause data to be reformatted and printed onto paper or other tangible surface.

While the present invention is primarily described in terms of a client computer accessing one or more web sites over a network, one skilled in the art would recognize that the present invention may work equally well on a single computer, as well as distributed across a series of networked computers. One will also appreciate that the present invention may be hosted on a public network such as the internet, or may be hosted by a private network, such as an intranet. For example, here, the present invention is disclosed as part of a website having the URL http://www.data360.org. One skilled in the art would similarly appreciate that the present invention need not be tied to a single URL or website, and that the present invention can be accessed on any number of available domain names, Internet or Intranet sites.

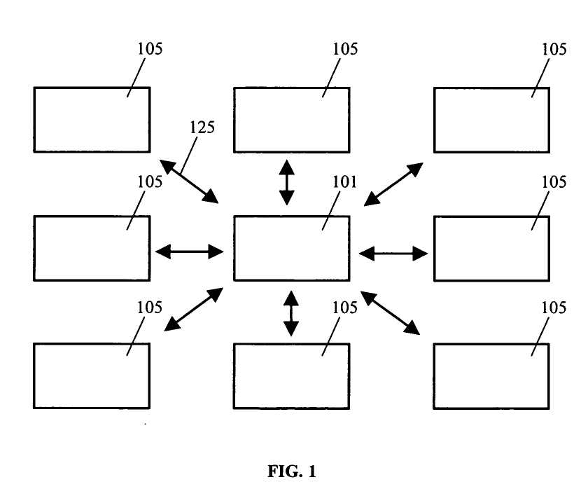

As shown in FIG. 1, an embodiment of the present invention may be hosted on a server computer 101, to which one or more client computers 105 are connected over a network 125. One will appreciate that FIG. 1 illustrates one way to set up and communicate with aspects of the present invention, but that other modalities are possible without departing from the scope of the invention or the disclosure herein.

### Data Entry and Data Storage

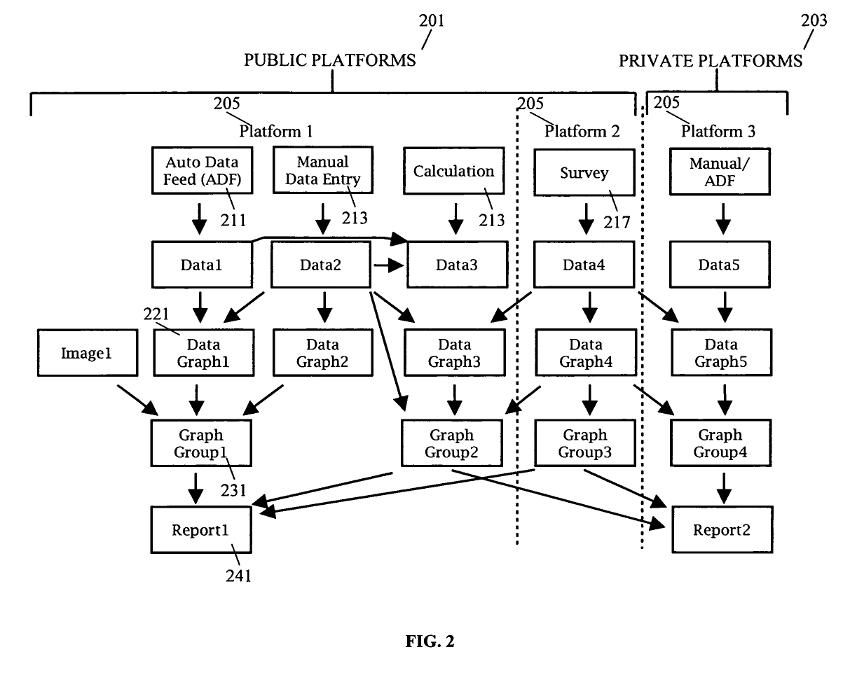

The various elements of an embodiment of the present invention, and the relationships between elements are illustrated in FIG. 2. One will appreciate that FIG. 2 is merely an example of how data may be provided to, used by and displayed by the present invention. For example, in one embodiment, data is added to and organized according to specific “platforms” (205 of FIG. 2). This method of organization may permit a user or viewer to readily identify the organizers of the platform, as well as the sources for or relationship between sets of data. A platform may be the name of a company or group of users that provide the data, or may be some other top-level categorization that identifies a set or sets of data and their associated reports. The platform may be public (201 of FIG. 2), which means data may be openly viewed by anyone. The platform may be private (203 of FIG. 2), which means only platform members or other designated persons may view the data. One skilled in the relevant art will appreciate that the term platform is merely illustrative and is not meant to define or limit the organization of aspects of the present invention.

In one embodiment, data may be added to a platform by importing a file, by manually entering data (213), or by linking to an outside web feed that supplies data periodically in XML format or other similar automated data feed format (211). Data may also be added by manipulating or performing calculations on data previously stored (215). For example, FIG. 2 illustrates that Data3 (215) may be the result of calculations performed on Data1 and Data2. One will appreciate that data may also be added by linking to another website that stores data, such as an online office suite, an online database, or an online data management system.

An embodiment of the present invention permits the hosting of and usage of survey data, either gathered by aspects of the present invention or uploaded to the servers hosting the present invention. The results of such surveys may be used as data sets themselves (217), for manipulation into other data sets, or for other elements of the present invention.

In one embodiment, data may be updated by an authorized updater. Updating privileges may be assigned by an account administrator who may also set the scope of privileges for the updater or updaters. An administrator may also permit public access and use of her data, or may restrict such access by setting it as private. An administrator may also restrict data viewing and usage to authorized users.

In one embodiment, the data is a series of data points or values over a period of time. In another embodiment, the data is series of records, each with multiple fields, that have no specified relationship with time. For example, the data may be a list of companies, schools, associations, people, works of art, books, or any subject in which a person or group of people has an interest. One will appreciate that the data may be associated with any number of values or representations, so long as it may be put in a format for display.

One will appreciate that in one embodiment of the present invention, all of the data used by the present invention may be stored in a central relational database. One skilled in the art will appreciate that the database may be centrally located or distributed across more than one computer. In one embodiment, the database is created, modified, retrieved, manipulated and queried using Structured Query Language (“SQL”). According to an embodiment, the database may be managed by a commercially available relational database management system like Microsoft SQL Server. One skilled in the art will recognize that many relational database management systems exist in the marketplace, and that alternative query languages may be developed to access an embodiment of the present invention. In one embodiment, relational database management systems such as provided by Oracle, IBM, Sybase and Apache might be implemented with the present invention.

Access to certain aspects of the present invention may require the creation of an account with the host website. This may entail joining or identifying membership with a platform. This may also entail logging into the hosted website in order to interact with certain aspects of the present invention, including data upload, access or manipulation. In one embodiment, a user may need to register or create an account with the system provider in order to have authority to perform data management tasks.

In one embodiment, users must create their account through a main platform, such as the data360.org platform. A user may then create a new platform “newco”, which may be given the subdomain newco.data360.org. In one embodiment, a user who creates a new platform will be the administrator (“admin”) for that platform, although subsequent users of that platform may also receive “admin” privileges. The initial user for a platform may be given admin privileges, which may permit editing and updating capabilities with that newly created platform. The initial user for a platform may also be given “analyst” privileges, in which case they are permitted to make commentary on selected graph groups and other elements of the that platform. An admin may add identifying and marketing information about the platform in order to advertise or inform viewers about the platform. In another embodiment, a user may access certain features of the present invention without creating an account or creating a platform. The present invention allows for an unlimited number of additional platforms, each of which can be public or private and each of which may have an unlimited number of admins, updaters, analysts or users.

In one embodiment, the admin, or any user given such privileges by the admin, may create a set of data once a platform is set up. To initiate the creation of a new data set, an embodiment of the present invention may provide a link to another portion of the website that will open up one or more dialog boxes permitting data set creation. This dialog box may allow the user to specify the type of data set to be inputted, including, for example, such options as Not Calculated; Not Calculated, Auto Data Feed; Not Calculated, Text Only; Simple Calculated Data Set; Time Period Calculated Data Set; and Month or Year to Date Calculation. One will appreciate that many different types of data sets may be available to a user.

In one embodiment, data that is entered manually is “not calculated.” In another embodiment, “not calculated” data can also be imported using an XML or other automated data feed from an external website or source. In another embodiment, if the user wishes to do calculations on one or more existing data sets to create a new data set, then the user may choose the “simple calculated data set” option. This embodiment may permit the user to manipulate or customize multiple sets of data on the server, potentially from different platforms, allowing the user to portray a different aspect of the data in order to uncover alternative theories of relevance. If the user selects simple calculated data set entry, then the user may have the opportunity to enter in a mathematical formula to apply to an existing data set, or to certain data points within an existing data set. The user may also apply a specific calculation to an existing data set or portions of the existing data set. An embodiment of the present invention will display the calculations used so that viewers of the data and associated reports may know exactly where and how the data originated.

In one embodiment, a user may apply a time period calculation to preexisting data. Time period calculations permit a user to take a previous data set and convert it from one time frequency iteration to another. In one embodiment, the user is converting a daily set of data into a weekly set of data and would have the choice of summing the daily values to reach a weekly value, of averaging the daily values to reach a weekly value or of taking the last (most recent) data point to reach a weekly value. One skilled in the art would appreciate that other time period calculations can be included without departing from the scope of the present invention. For example, a user may apply time frequencies of seconds, minutes and hours, as well as decades, centuries and millennia. In addition, other methods of converting one time frequency to another time frequency might be added.

Data may be provided from third party websites or programs. For example, in one embodiment a user may upload data with a CSV-formatted spreadsheet. This spreadsheet may originate from an offline office spreadsheet creator such as Microsoft Excel, or an online spreadsheet creator such as Google or Zoho or other web-based office application. In another embodiment, data may be provided from a particular source, but be limited to certain focused sets of data from within that source, such as a time limitation or other such limitation.

One skilled in the art would appreciate that as more options for conceptualizing data become available to the user, these new options may be incorporated in the present invention without falling outside the scope of this disclosure. For example, an embodiment limits a data set to having one data point per time iteration. Another embodiment would permit multiple data points per time iteration. A further embodiment would permit variables beyond a simple X-Y plot to allow for data sets having multiple dimensions, such as an X-Y-Z plot, indicating three dimensional data.

According to one embodiment of the present invention, a next step of the data input process may permit a user to enter information in editable fields describing the data set. In an embodiment, a user may enter a Data Set Name, Data Set Tags, a Data Set Legend, and the like. A user may specify if the inputted data should be made publicly available or kept private. A user may specify who may update the data with new data (“updater” privileges). A data set can be edited at any time by an authorized updater, using any of the methods previously disclosed.

### Data Manipulation, Organization and Usage

In one embodiment, one or more sets of data may be organized into a data graph (221). FIG. 2 illustrates that DataGraph1 may be formed using data from Data1 and Data2. A data graph may have a graphical representation associated with it, which may be a line graph, bar graph or any other kind of two-dimensional or three-dimensional graph or chart able to represent data, including but not limited to animations or slideshow presentations. One embodiment of the data graph can include data from sources or platforms outside of the user's platform.

A data graph can include data sets from any of the data stored on public platforms in the database or Data360 system. In one embodiment, if data is private, then only authorized users and platform members will be able to use that data to create a data graph, although in one embodiment, a private platform may also use data and graphs from public platforms. An embodiment may permit the combination of data from one platform into another platform's data graph. This flexibility allows a user to create data graphs out of data from seemingly divergent sources in order to examine how the different sets of data relate. An embodiment of the present invention also allows for the application of statistical or other mathematical analysis on the data.

In one embodiment, one or more data graphs are further organized into what is termed an issue group. According to one embodiment, an issue group is a group of related data graphs. In another embodiment, one or more data graphs are organized into a graph group, which is a collection of one or more data graphs, data sets, text or uploaded files, all displayed on a single page (231). As depicted in FIG. 2, GraphGroup1 may consist of Image1, DataGraph1 and DataGraph2. One will appreciate that graph groups may include other media beyond the data uploaded to the system. In addition, one will appreciate that, because the data graphs may be correlated to an issue group, the graph groups related to those data graphs may also be part of an issue group or issue groups. In one embodiment, a user's subdomain home page on the host website displays graph groups under their respective issue groups as they are linked through their respective data graphs.

As different platforms or users create data graphs, it may be useful to provide a way to show all of the data graphs together. In an embodiment, the graph group display may be customized to show data graphs in a number of configurations, such as a page having one or more graphical representations oriented in either landscape or portrait format. In one embodiment, multiple data graphs may be displayed in a grid configuration. One will appreciate that graph groups may be manipulated for display in a number of different formats, so long as it satisfies the goal of the present invention, which is to enable a viewer to easily and efficiently identify the relationships between data sets from one or more sources or platforms.

### Data Reports and Commentary

Aside from permitting the display of data in data graphs and then as graph groups and/or issue groups, an embodiment of the present invention provides for the generation of reports and the storage of user commentary and ratings of data. A report is one mechanism for generating displays of graph groups and other user-uploaded files. For example, data, data graphs or graph groups from other public or private platforms may be used to build a report (241 of FIG. 2). Authorized users can also use the present invention to associate additional files with the report, including customizable web pages, linked documents, slide shows, animations or other graphic user interface files. In other embodiments, the data can be presented in any number of ways, including grids, radial charts, 3-dimensional charts, multiple-pane charts, tabbed displays and other data visualization techniques. One embodiment for compiling, formatting and display of charts, tables and graphical representations of the present invention may be handled by commercially available charting software like Software FX, Inc.'s Chart FX. (Available at http://www.softwarefx.com/). One skilled in the art will appreciate that alternative charting software may be implemented in conjunction with the present invention, including Corporate Web Solutions Ltd.'s .netCHARTING (http://www.dotnetcharting.com/), Microsoft Excel (http://www.microsoft.com), Crystal Xcelsius (http://www.xcelsius.com/), NetCharts (http://www.visualmining.com/) and the like.

In one embodiment, the present invention provides data for other software applications. Data graphs, graph groups, reports and other configurations of the data set may be exported as PDF files, rich text files, spreadsheet files, CSV files, word processor files, presentation files, web pages or any other file types that can be imported into or used by other commercial software applications. In another embodiment, the graphical representations themselves may be downloaded and exported as GIF, JPG, BMP, Flash or other image file. Hyperlinks to various aspects of the present invention may be embedded into a web page where multiple graphs are displayed. In one embodiment, the present invention may enable online viewing of a slide show presentation. Here, the user may present the data to others, or cause others to access data such that a slide show report can be viewed online. The viewer can navigate through the slides much as she would during a PowerPoint or similar-type digital slide show, with the important benefit of all of the underlying data and sources being accessible, which leads users to gaining more certitude about the veracity of the data. In this aspect, embodiments of the present invention may provide users, private organizations and other groups with a single site for storing, manipulating, observing and publishing data important to those users, private organizations or groups. The data may be annotated with information disclosing the source, relevance and relationships between data, and may be published to others for assessment.

In an embodiment of the present invention, users may upload commentary to the displayed graph groups. In one embodiment of the present invention, users may have the ability to comment on or rate any aspect or limited aspects pertaining to the uploaded data or any other display of the data. This embodiment adds a social networking aspect to the present invention, thus encouraging users to offer up unbiased data, since others may have the ability to comment and rate. According to an embodiment, in addition to setting up user accounts and linking data, the admin may also designate persons as “analysts” on the displayed data in a graph group, offering typed, video or audio feedback on the data in a graph group. An analyst may provide some displayed notes pertaining to the displayed graphs. In yet a further embodiment, all aspects of a platform's data sets, data graphs, graph groups, reports, and any other component of the present invention visible to users are open to commentary in typed, audio and video formats.

In the foregoing, a system has been described for submitting and processing data from multiple platforms for display. Although the present invention has been described with reference to specific exemplary embodiments, it will be evident that various modifications and changes may be made to these embodiments without departing from the broader spirit and scope of the invention as set forth in the claims. For example, while the present invention has been disclosed as residing on a web server, accessed by a client computer, one skilled in the art will appreciate that the present invention may be distributed across a broad network of computers or servers, and may be accessed with a myriad of computing devices. Accordingly, the specification and drawings are to be regarded in an illustrative rather than restrictive sense.

What is claimed is:

1. A process comprising:
receiving, by a server computer on a network, a first data set having one or more data values;
receiving, by the server computer, a second data set having one or more data values;
applying, by the server computer, a selected mathematical formula to one or more data values from the first data set or the second data set;
combining, by the server computer, the first data set and the second data set to form one or more data graphs; and
providing, by the server computer, access to a display of the one or more data graphs.

2. The process of claim 1, wherein the first data set is received from a different source than the second data set.

3. The process of claim 1, further comprising combining, by the server computer, one or more data graphs to form one or more graph groups.

4. The process of claim 1, further comprising combining, by the server computer, one or more data graphs to form one or more issue groups.

5. The process of claim 3, further comprising generating, by the server computer, a report having a graphical representation of the one or more graph groups.

6. The process of claim 1, wherein the first receiving step or the second receiving step comprises manual entry of data set values.

7. The process of claim 1, wherein the first receiving step or the second receiving step comprises importing data set values from a file.

8. The process of claim 1, wherein the first receiving step or the second receiving step comprises importing data set values from an automated data feed.

9. The process of claim 1, wherein the first receiving step or the second receiving step comprises receiving the results of one or more calculations on data values previously stored in the server computer.

10. The process of claim 1, wherein the combining step comprises statistically correlating data values.

11. The process of claim 3, further comprising providing, by the server computer, the capability of viewing user-inputted comments about the one or more graph groups.

12. The process of claim 4, wherein the report further comprises audio or video data displayed with the graphical representation of one or more graph groups.

13. A computer program product encoded in a medium and including instructions for:
receiving, by a server computer on a network, a first data set having one or more data values;
receiving, by the server computer, a second data set having one or more data values;
applying, by the server computer, a selected mathematical formula to one or more data values from the first data set or the second data set;
combining, by the server computer, the first data set and the second data set to form one or more data graphs;
combining, by the server computer, one or more data graphs to form one or more graph groups;
providing, by the server computer, access to a display of the one or more graph groups; and
generating, by the server computer, a report having a graphical representation of the one or more graph groups.
